(19) United States
(12) Patent Application Publication
(10) Pub. No.: US 2008/0080379 A1
(43) Pub. Date: Apr. 3, 2008

(54) NETWORK DEVICE AND FRAME PROCESSING METHOD THEREOF

(75) Inventor: Chien-Hua Chen, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/625,286

(22) Filed: Jan. 20, 2007

(30) Foreign Application Priority Data
Sep. 29, 2006 (TW) 95136379

(51) Int. Cl. H04J 3/14; H04J 1/16

(52) U.S. Cl. 370/235; 370/252

(57) ABSTRACT

A network device connected to a client is provided. The network device includes a rate determination module, a detection module, a setting module and a transmission module. The rate determination module is for determining a plurality of constant transmission rates of transmitting frames. The detection module is for beginning with the last frame of the streaming file sequentially detecting whether a size of each of the frames is greater than a preset value. The setting module is for redistributing a frame size greater than the preset value. The transmission module is for transmitting the frames to the client according to the plurality of constant transmission rates. A frame processing method is also provided.

### BACKGROUND OF INVENTION

1. Field of the Invention

The invention generally relates to wireless communication, and particularly to a network device and frame processing method thereof.

2. Description of Related Art

Compared with other types of video files, a motion picture expert group layer 4 (MPEG-4) file has a higher compression rate and a better picture quality, and occupies less network bandwidth, therefore the MPEG-4 file is especially suitable for an Internet-based streaming transmission.

However, transmissions of MPEG-4 files come in bursts, which involves rapid variation in transmission rates. When transmission rates exceed a maximum permissible rate of a buffer of a client, packet loss may take place.

### SUMMARY OF THE INVENTION

A network device connected to a client is provided. The network device includes a rate determination module, a detection module, a setting module, and a transmission module. The rate determination module is for determining a plurality of constant transmission rates of frame transmission. The detection module is for sequentially detecting whether a size of each of the frames is greater than a preset value. The setting module is for redistributing a frame size greater than the preset value. The transmission module is for transmitting the frames to the client according to the plurality of constant transmission rates.

A frame processing method applicable to a network device connected to a client. The frame processing method includes: determining a plurality of constant transmission rates of frame transmission; sequentially detecting whether a size of each of the frames is greater than a preset value; redistributing bits of a frame greater in size than the preset value; and transmitting the frames to the client according to the plurality of constant transmission rates.

Other advantages and novel features will become more apparent from the following detailed description when taken in conjunction with the accompanying drawings, in which:

### BRIEF DESCRIPTION OF THE DRAWINGS

FIG. 1 is a diagram illustrating an application environment of a network device of an embodiment of the invention;

FIG. 2 is a block diagram of the network device of the embodiment of the invention;

FIG. 3 is a diagram of determining a plurality of longest constant transmission rates; and

FIG. 4 is a flowchart of a frame processing method of a further embodiment of the invention.

### DETAILED DESCRIPTION OF THE INVENTION

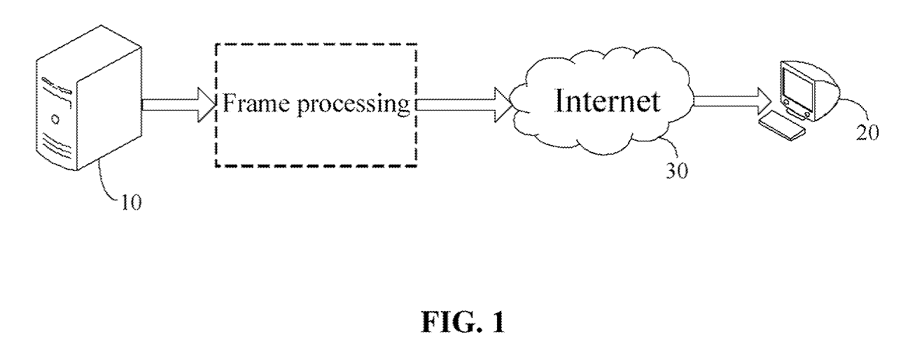

FIG. 1 is a diagram illustrating an application environment of a network device 10 of an embodiment of the invention.

The network device 10 processes frames of a streaming file then transmits the file to a client 20 via a network 30. In this embodiment, the network device 10 is a content server, the client 20 is a personal computer (PC), the network 30 is the Internet, and the streaming file is a motion picture expert group layer 4 (MPEG-4) file. The streaming file is composed of a plurality of frames. A buffer is arranged in the client 20, for buffering the frames from the network device 10. In this embodiment, a size of the buffer is B bits.

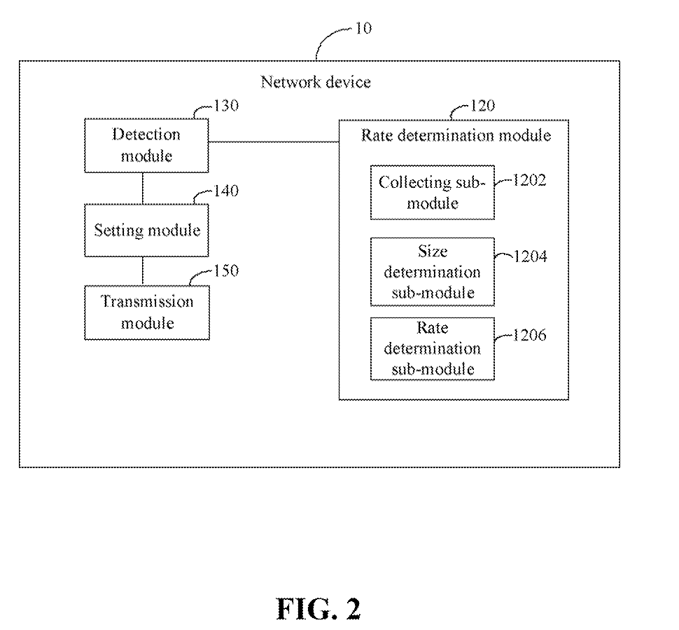

FIG. 2 is a block diagram of the network device 10 of the embodiment of the invention.

The network device 10 includes a rate determination module 120, a detection module 130, a setting module 140, and a transmission module 150.

The rate determination module 120 determines a plurality of longest constant transmission rates of the frames. The rate determination module 120 includes a collecting sub-module 1202, a size determination sub-module 1204, and a rate determination sub-module 1206.

The collecting module 1202 collects a time interval between frame transmission. In this embodiment, the time interval is represented by T.

The collecting module 1202 further collects the minimum frame sizes cumulatively received by the client 20 at different times. The minimum frame sizes cumulatively received by the client 20 at different times are sizes of frames played by the client 20 at different times. In detail, the collecting module 1202 collects the minimum frame sizes cumulatively received by the client 20 at different times by reading a header field of the streaming data from the network device 10. In this embodiment, the minimum frame sizes cumulatively received by the client 20 at time t₀, t₁, . . . , t₆ are represented by D(t₀), D(t₁), . . . , D(t₆), respectively. If the frame sizes cumulatively received by the client 20 at different times are less than the minimum frame sizes, underflow of the buffer in the client 20 will occur.

The size determination sub-module 1204 determines the maximum frame sizes cumulatively received by the client 20 at different times according to the minimum frame sizes cumulatively received by the client 20 at different times and a buffer size B of the client 20. In this embodiment, the maximum frame sizes cumulatively received by the client 20 at time t₀, t₁, . . . , t₆ are respectively represented by B(t₀), B(t₁), . . . , B(t₆), and B(t₀)=D(t₀)+B, B(t₁)=D(t₁)+B, . . . , B(t₆)=D(t₆)+B. If the frame sizes cumulatively received by the client 20 at different times are greater than the maximum frame sizes, overflow of the buffer in the client 20 will occur.

The rate determination sub-module 1206 determines a plurality of constant transmission rates according to the minimum frame sizes and the maximum frame sizes at different times, in order to enable each of the constant transmission rates to have a longest duration, and to ensure that overflow or underflow of the client buffer does not occur. In this embodiment, only the first constant transmission rate Rate(1) and the second constant transmission rate Rate(2) are illustrated.

From time t₀, the rate determination sub-module 1206 sequentially determines the first constant transmission rate Rate(1) and the second constant transmission rate Rate(2), to enable the first constant transmission rate Rate(1) and the second constant transmission rate Rate(2) to have the longest duration 4T and 2T, respectively.

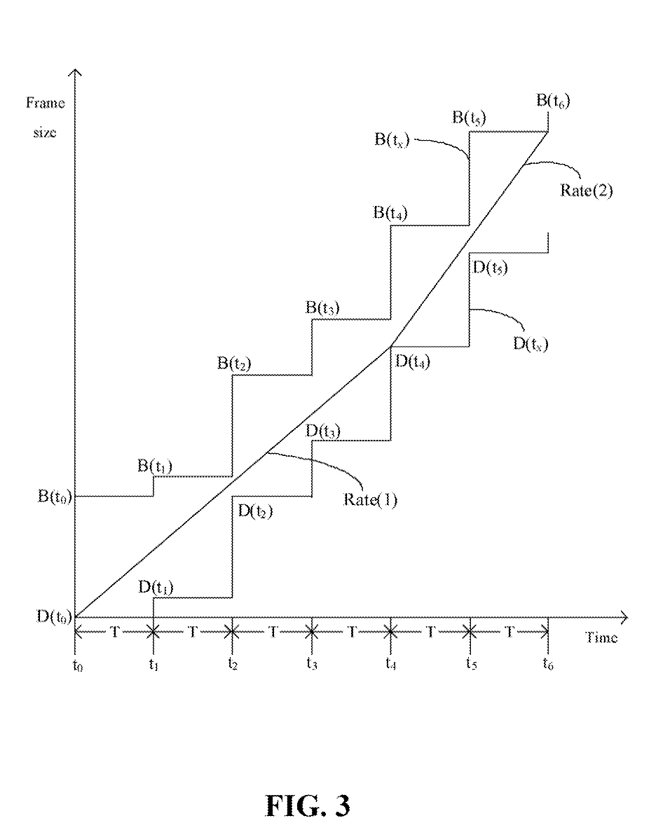

As shown in FIG. 3, the rate determination sub-module 1206 determines that the first constant transmission rate Rate(1) begins at time t₀, ends at time t₄, and equals [D(t₄)−D(t₀)]/4T, this is because that in time intervals between t₀ and t₁, t₀ and t₂, t₀ and t₃, and t₀ and t₄, the overall sizes of frames transmitted at the first constant transmission rate Rate(1): T*Rate(1), 2T*Rate(1), 3T*Rate(1) and 4T*Rate(1) are less than the maximum frame sizes cumulatively received by the client 20 at corresponding time: B(t₁), B(t₂), B(t₃), and B(t₄), and are greater than the minimum frame sizes cumulatively received by the client 20 at corresponding time: D(t₁), D(t₂), D(t₃), and D(t₄). In a next time interval following time t₄, if the frames are still transmitted at the first constant transmission rate Rate(1), it can be seen from FIG. 3 that at time t₅, the overall size of the frames transmitted is less than the minimum frame size cumulatively received by the client 20 so a second constant transmission rate Rate(2) must be used.

The determination of the second constant transmission rate Rate(2) is similar to that of the first constant transmission rate Rate(1). In this embodiment, the second constant transmission rate Rate(2) equals to [B(t₅)−D(t₄)]/2T.

The detection module 130 sets a preset value, and beginning with the last frame of the streaming file sequentially detects whether a size of each of the frames is greater than a preset value. In this embodiment, the preset value is equal to 40 bits.

The setting module 140 redistributes bits of frames greater in size than the preset value. In detail, the setting module 140 redistributes excess bits to a next frame to be checked. For example, if a size of a frame is 60 bits, the setting module 140 redistributes 20 bits to the next frame.

The transmission module 150 transmits the frames to the client 20 according to the constant transmission rates.

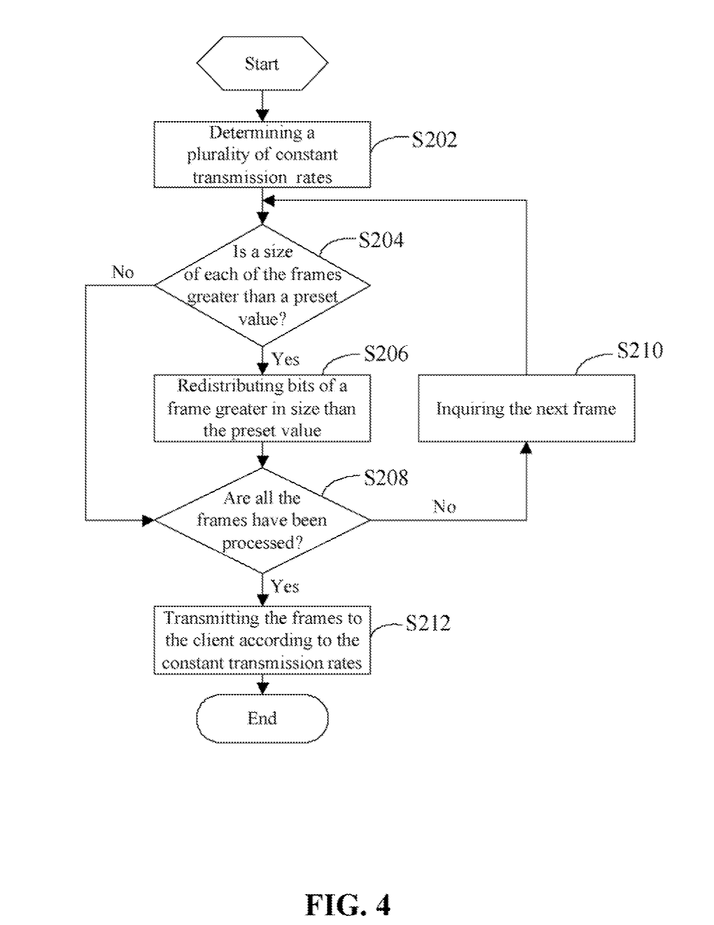

FIG. 4 is a flowchart of a frame processing method of a further embodiment of the invention.

In step S202, the rate determination module 120 determines a plurality of constant transmission rates of the frames, in order to enable each of the constant transmission rates to have a longest duration, and to make overall size of the frames transmitted at the constant transmission rate at different times in the duration smaller than the maximum frame sizes cumulatively received by the client 20 at corresponding times, and greater than the minimum frame sizes cumulatively received by the client 20 at corresponding times.

As shown in FIG. 3, the rate determination sub-module 1206 determines that the first constant transmission rate Rate(1) begins at time t₀, ends at time t₄, and equals to [D(t₄)−D(t₀)]/4T, this is because that in time intervals between t₀ and t₁, t₀ and t₂, t₀ and t₃, and t₀ and t₄, the overall sizes of frames transmitted at the first constant transmission rate Rate(1): T*Rate(1), 2T*Rate(1), 3T*Rate(1) and 4T*Rate(1) are smaller than the maximum frame sizes cumulatively received by the client 20 at corresponding times: B(t₁), B(t₂), B(t₃), and B(t₄), and are greater than the maximum frame sizes cumulatively received by the client 20 at corresponding times: D(t₁), D(t₂), D(t₃), and D(t₄). In a next time interval following time t₄, if the frames are still transmitted at the first constant transmission rate Rate(1), it can be seen from FIG. 3 that at time t₅, the overall size of the frames transmitted is less than the minimum frame size cumulatively received by the client 20 so a second constant transmission rate Rate(2) must be used.

In step S204, the detection module 130 sets a preset value, and sequentially detects whether a size of each of the frames is greater than a preset value. If a size of one of the frames is greater than the preset value, the process proceeds to step S208, otherwise the process proceeds to step S210. In this embodiment, beginning with the last frame of the streaming file and working back to the first frame, the detection module 130 sequentially detects whether the size of each of the frames is greater than 40 bits.

In step S206, the setting module 140 redistributes bits of a frame greater in size than the preset value. In detail, the setting module 140 redistributes excess bits to a next frame to be checked. For example, if a size of a frame is 60 bits, the setting module 140 redistributes 20 bits to the next frame.

In step S208, the detection module 130 detects whether all the frames have been processed. If not all the frames are processed, the process proceeds to step S210, otherwise the process proceeds to step S212.

In step S210, the detection module 130 checks the next frame.

In step S212, the transmission module 150 transmits the frames to the client 20 according to the constant transmission rates.

In other embodiments, step S204 and S206 may be processed prior to step S202.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments.

What is claimed is:

1. A network device connected to a client, comprising:
a rate determination module for determining a plurality of constant transmission rates of transmitting frames;
a detection module for beginning with the last frame of the streaming file sequentially detecting whether a size of each of the frames is greater than a preset value;
a setting module for redistributing bits of a frame greater in size than the preset value if a size of one of the frames is greater than the preset value; and
a transmission module for transmitting the frames to the client according to the plurality of constant transmission rates.

2. The network device in accordance with claim 1, wherein the rate determination module comprises a collecting module for collecting a time interval of transmitting the frames.

3. The network device in accordance with claim 2, wherein the rate determination module is further for collecting minimum frame sizes cumulatively received by the client at different time.

4. The network device in accordance with claim 3, wherein the rate determination module further comprises a size determination sub-module for determining maximum frame sizes cumulatively received by the client at different time according to the minimum frame sizes cumulatively received by the client at different time and a buffer size of the client.

5. The network device in accordance with claim 4, wherein the rate determination module further comprises a rate determination sub-module for determining a plurality of constant transmission rates according to the minimum frame sizes and the maximum frame sizes cumulatively received by the client at different time.

6. A frame processing method applicable to a network device connected to a client, comprising:
determining a plurality of constant transmission rates of transmitting frames;
beginning with the last frame of the streaming file sequentially detecting whether a size of each of the frames is greater than a preset value;
redistributing bits of a frame greater in size than the preset value if a size of one of the frames is greater than the preset value; and
transmitting the frames to the client according to the plurality of constant transmission rates.

7. The frame processing method in accordance with claim 6, wherein the step of determining a plurality of constant transmission rates of transmitting frames comprises collecting minimum frame sizes cumulatively received by the client at different time.

8. The frame processing method in accordance with claim 7, wherein the step of determining a plurality of constant transmission rates of transmitting frames further comprises determining maximum frame sizes cumulatively received by the client at different time according to the minimum frame sizes cumulatively received by the client at different time and a buffer size of the client.

9. The frame processing method in accordance with claim 8, wherein the step of determining a plurality of constant transmission rates of transmitting frames further comprises determining a plurality of constant transmission rates according to the minimum frame sizes and the maximum frame sizes cumulatively received by the client at different time.

10. The frame processing method in accordance with claim 6, wherein the step of redistributing bits of a frame greater in size than the preset value if a size of one of the frames is greater than the preset value comprises redistributing an excess frame to a next frame to be checked.

11. A method to process frame transmission from a network device to a client data-communicable with said network device, comprising steps of:
determining minimum frame sizes of transmissible frames correspondingly acquired at different time intervals, and determining maximum frame sizes based on said corresponding minimum frame sizes and a buffer size of a client;
determining a plurality of constant transmission rates to transmit said frames respectively from a network device to said client data-communicable with said network device based on said determined minimum frame sizes and said determined maximum frame sizes;
comparing a size of each of said frames with a preset value;
redistributing excess bits of said each of said compared frames when said size of said each of said compared frames is greater than said preset value; and
transmitting said frames from said network device to said client according to said determined plurality of constant transmission rates.

12. The method in accordance with claim 11, wherein said excess bits of said each of said compared frames is rearranged to a next frame sequentially next to said each of said compared frames.
